(19) United States
(12) Patent Application Publication
(10) Pub. No.: US 2022/0382832 A1
(43) Pub. Date: Dec. 1, 2022

(54) ELECTRONIC APPARATUS AND METHOD FOR PROCESSING DATA THEREOF

(71) Applicants: SAMSUNG ELECTRONICS CO., LTD., Suwon-si (KR); INDUSTRIAL COOPERATION FOUNDATION JEONBUK NATIONAL UNIVERSITY, Jeonju-si (KR); IUCF-HYU (INDUSTRY-UNIVERSITY COOPERATION FOUNDATION HANYANG UNIVERSITY), Seoul (KR)

(72) Inventors: Jinsu KIM, Suwon-si (KR); Jae Hong SEO, Seoul (KR); Hyung Tae LEE, Jeonju-si (KR)

(73) Assignees: SAMSUNG ELECTRONICS CO., LTD., Suwon-si (KR); INDUSTRIAL COOPERATION FOUNDATION JEONBUK NATIONAL UNIVERSITY, Jeonju-si (KR); IUCF-HYU (INDUSTRY-UNIVERSITY COOPERATION FOUNDATION HANYANG UNIVERSITY), Seoul (KR)

(21) Appl. No.: 17/882,331

(22) Filed: Aug. 5, 2022

Related U.S. Application Data
(63) Continuation of application No. PCT/KR2021/000195, filed on Jan. 7, 2021.

(30) Foreign Application Priority Data
Feb. 5, 2020 (KR) 10-2020-0013557

(51) Int. Cl. G06F 17/16; G06F 7/544

(52) U.S. Cl. CPC G06F 17/16; G06F 7/5443

(57) ABSTRACT

A data processing method includes selecting, as a codeword, a vector from among a plural vectors, the vector including multiple elements and having a predetermined size, generating a helper matrix by using the codeword and real number data that corresponds to biometric information, and outputting helper matrix.

### CROSS-REFERENCE TO RELATED APPLICATIONS

This application is a continuation application of International Application No. PCT/KR2021/000195 filed Jan. 7, 2021, which is based on and claims priority claims priority under 35 U.S.C. § 119 to Korean Patent Application No. 10-2020-0013557 filed on Feb. 5, 2020, in the Korean Intellectual Property Office, the disclosures of each of which being incorporated by reference herein in their entireties.

### BACKGROUND

### 1. Field

The disclosure relates to an electronic apparatus and a method for processing data thereof, and more particularly, to an electronic apparatus capable of performing error correction on real number data and a method for processing data thereof.

### 2. Description of Related Art

Recently, a necessity for security of user information or device information has emerged. According to this necessity, interest in authentication technology using biometric data is growing.

Biometric data may include, for example, a fingerprint, an iris, a face, and a voice, and various other biometric information may be used.

Recently, a fuzzy extraction technology that extracts an encryption key directly from biometric information has been used. However, the related-art fuzzy extraction technology is only applicable to binary data, and is difficult to be applied to real number data.

### SUMMARY

Provided are an electronic apparatus capable of performing error correction on real number data and a method for processing data thereof.

Additional aspects will be set forth in part in the description which follows and, in part, will be apparent from the description, or may be learned by practice of the presented embodiments.

In accordance with an aspect of the disclosure, there is provided a data processing method comprising selecting, by at least one processor as a codeword, a vector from among a plurality of vectors, the vector comprising multiple elements and having a predetermined size; generating, by the at least one processor, a helper matrix by using the codeword and real number data; and outputting, by the at least one processor, the helper matrix.

In accordance with another aspect of the disclosure, there is provided an electronic apparatus comprising a memory that stores at least one instruction; and a processor that loads the at least one instruction and executes the at least one instruction, wherein the processor, by executing the at least one instruction, selects, as a codeword, a vector of a plurality of vectors, the vector comprising a plurality of elements and having a predetermined size, generates a helper matrix by using the codeword and real number data, and outputs the helper matrix.

In accordance with another aspect of the disclosure, there is provided a system comprising an electronic apparatus and a server. The electronic apparatus includes a sensor that senses biometric information and generates first real number data based on the biometric information, and a communication interface that transmits the first real number data to the server. The server includes a memory that stores at least one instruction, and at least one processor that loads the at least one instruction and executes the at least one instruction to at least select, as a codeword, a first vector of a plurality of vectors, the first vector comprising a plurality of elements and having a predetermined size; generate a helper matrix by using the codeword and second real number data; receive the first real number data from the electronic apparatus; calculate a second vector comprising a plurality of elements by reflecting the first real number data to the helper matrix; and determine equality of the second vector and the codeword that corresponds to the helper matrix.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating an electronic system according to an embodiment;

FIG. 2 is a block diagram illustrating a configuration of an electronic apparatus according to an embodiment;

FIG. 3 is a block diagram illustrating a detailed configuration of an electronic apparatus, according to an embodiment;

FIG. 4 is a block diagram illustrating a configuration of a server device according to an embodiment;

FIG. 5 is a conceptual diagram illustrating a fuzzy extractor according to an embodiment;

FIG. 6 is a diagram illustrating a fuzzy extraction operation according to an embodiment;

FIG. 7 is a diagram illustrating a fuzzy extraction operation according to an embodiment;

FIG. 8 is a diagram illustrating an operation of a generation module and a decoding module according to an embodiment;

FIG. 9 is a flowchart illustrating a data processing method according to an embodiment; and

FIG. 10 is a flowchart illustrating a data processing method according to an embodiment.

### DETAILED DESCRIPTION

The disclosure will be described in greater detail with reference to the attached drawings.

Terms used in this specification will be briefly described, and the disclosure will be described in detail.

The terms used in the disclosure and the claims are general terms identified in consideration of the functions of embodiments of the disclosure. However, these terms may vary depending on intention, legal or technical interpretation, emergence of new technologies, and the like of those skilled in the related art. In addition, in some cases, a term may be selected by the applicant, in which case the term will be described in detail in the description of the corresponding disclosure. Thus, a term used in this disclosure should be defined based on the meaning of term, not a simple name of the term, and the contents throughout this disclosure.

One or more specific embodiments of the disclosure are illustrated in the drawings and are described in detail in the detailed description. However, it is to be understood that the disclosure is not limited to the one or more specific embodiments, but includes all modifications, equivalents, and substitutions without departing from the scope and spirit of the disclosure and appended claims. Also, well-known functions or constructions are not described in detail since they would obscure the disclosure with unnecessary detail.

A singular expression includes a plural expression, unless otherwise specified. It is to be understood that the terms such as “comprise” may, for example, be used to designate a presence of a characteristic, number, step, operation, element, component, or a combination thereof, and not to preclude a presence or a possibility of adding one or more of other characteristics, numbers, steps, operations, elements, components or a combination thereof.

The expression “at least one of A and/or B” is to be understood as indicating “A” or “B” or “A and B”.

As used herein, the terms “1st” or “first” and “2nd” or “second” may use corresponding components regardless of importance or order and are used to distinguish one component from another without limiting the components.

If it is described that a certain element (e.g., first element) is “operatively or communicatively coupled with/to” or is “connected to” another element (e.g., second element), it should be understood that the certain element may be connected to the other element directly or through still another element (e.g., a third element).

Terms such as “module,” “unit,” “part,” and so on are used to refer to an element that performs at least one function or operation, and such element may be implemented as hardware or software, or a combination of hardware and software. Further, except for when each of a plurality of “modules,” “units,” “parts,” and the like needs to be realized in an individual hardware, the components may be integrated in at least one module or chip and be realized in at least one processor. In the disclosure, a “user” may refer to a person using an electronic apparatus or an artificial intelligence electronic apparatus using an electronic apparatus (e.g., artificial intelligence electronic apparatus).

Embodiments of the disclosure will be described in detail with reference to the accompanying drawings to aid in the understanding of those of ordinary skill in the art. However, the disclosure may be realized in various different forms and it should be noted that the disclosure is not limited to the various embodiments described herein. Further, in the drawings, parts not relevant to the description may be omitted, and like reference numerals may be used to indicate like elements.

Hereinafter, an embodiment will be described in more detail with reference to the accompanying drawings.

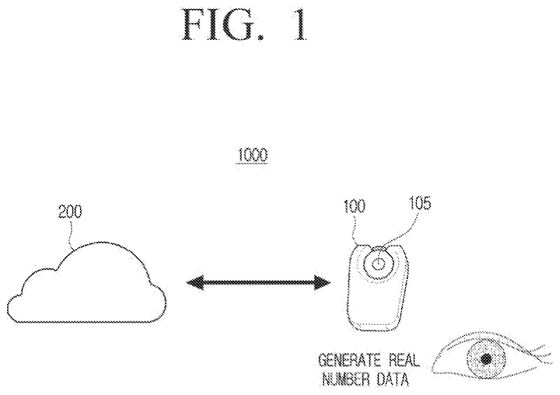

FIG. 1 is a diagram illustrating an electronic system according to an embodiment.

Referring to FIG. 1, an electronic system 1000 may include an electronic apparatus 100 and a server device 200. The electronic system 1000 may be referred to as a user authentication system in terms of performing a user authentication operation using user biometric information.

The electronic apparatus 100 generates real number data. For example, the electronic apparatus 100 may include a sensor 105 capable of extracting biometric information from the user's body, and may generate biometric information (or real number data) having a real number form by using the sensor.

The real number data may be biometric information such as the user's iris, retina, and/or voice information, and user information in real number form such as information indicating the location of the electronic apparatus 100 (e.g., signal strength, global positioning system (GPS) information, etc.) or device information.

The electronic apparatus 100 may generate a key by using the generated real number data. For example, the electronic apparatus 100 may generate a codeword, a helper matrix, and/or a vector.

Here, the codeword denotes a key used for user authentication, etc., and may be referred to as a secret key. In some embodiments, there may be a plurality of codewords. The codewords may be randomly generated. In detail, the electronic apparatus 100 may select one vector of a plurality of vectors as the codeword, where the selected vector (i.e., the codeword) is composed of a plurality of elements and has a preset size. In some embodiments, the selected vector (i.e., the codeword) may comprise a plurality of elements and may have a preset size. For example, in the codeword, 16 elements out of 512 elements may have a size of ¼ (i.e., a value of ±¼) and the remaining elements may have a value of 0. As such, since only 16 elements have a value of ±¼, the size of the generated codeword may have a value of 1.

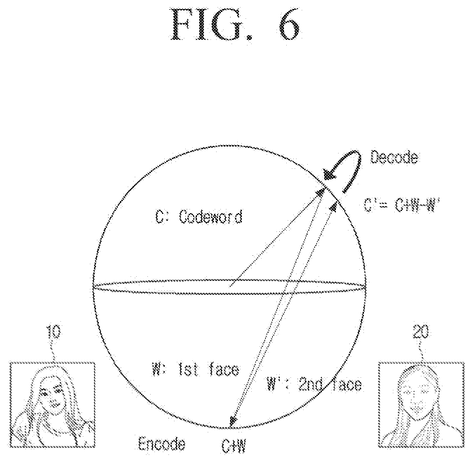

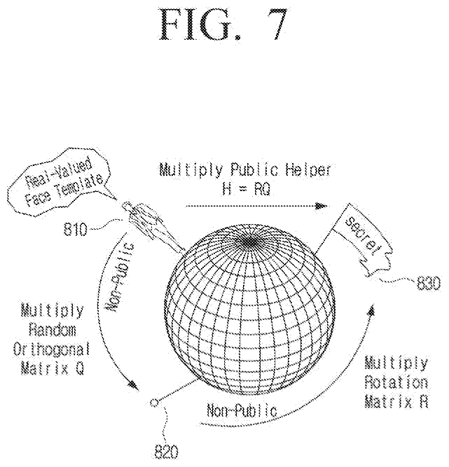

The helper matrix denotes a vector that relatively moves a value of a sphere surface relative to the surface of the sphere. The helper matrix is for converting real number information into a codeword (or vector), and may be referred to as a public key. In some embodiments, the helper matrix may include one movement operation, and in other embodiments, the helper matrix may include a plurality of movement operations. An example of an implementation of the helper matrix will be described later with reference to FIG. 6 or FIG. 7.

The vector is generated by reflecting the generated real number data to the helper matrix, and may be referred to as a codeword in that the vector corresponds to the above-described codeword. However, for convenience of description, hereinafter, a vector generated in an initial key generation process is referred to as a codeword, and a vector generated in the decoding process is referred to as a decoding codeword or a vector.

The electronic apparatus 100 may perform an error correction operation on the generated vector. Specifically, the electronic apparatus 100 may approximate the value of each element of the vector as a preset value or a zero value. For example, if only 16 of the 512 elements of the codeword have a size value of ¼ (that is, a value of ±¼), the vector generated by the helper matrix and real number data has a size of 1, and each element may have values such as ±¼ or an approximation to zero, for example, +0.25012,−0.0034, etc. Here, in this example, +0.25012 denotes a value of ±¼, and −0.0034 denotes a value approximating zero.

In this case, the electronic apparatus 100 may perform an error correction operation by approximating an element having a value close to 0.25 to a value of ¼, approximating an element having a value close to −0.25 to a value −¼, and approximating an element having a value close to 0 to 0. When the error correction operation is performed, in the vector, 16 out of 512 elements may have a value of ±¼ in the same manner as a codeword, and the rest of the elements may have a value of 0.

The electronic apparatus 100 may include, for example, a biometric information scanner, a smartphone, a tablet PC, a mobile phone, a video phone, a camera, an IR sensor device, a microphone device, a desktop PC, a laptop PC, a netbook computer, a workstation, a personal digital assistant (PDA), a portable multimedia player (PMP), an MP3 player, a medical device, or a wearable device, but embodiments are not limited thereto.

The server device 200 may perform user authentication based on the codeword received from the electronic apparatus 100. Specifically, the server device 200 may perform user authentication by comparing the information previously stored in the database with the encrypted biometric information received from the electronic apparatus 100.

For example, the server device 200 may store a codeword (C) value for user A, and when a codeword is received from the electronic apparatus 100, the server device 200 may perform user authentication by comparing the received codeword with the pre-stored codeword C.

If error correction is not performed on the codeword generated by the electronic apparatus 100, the server device 200 may calculate a dot product sum between the pre-stored codeword and the received codeword, and may identify equality (i.e., whether the pre-stored codeword is the same as the received codeword) based on whether the calculated dot product sum is smaller than the preset size.

When error correction is not performed on the codeword generated by the electronic apparatus 100, the server device 200 may perform user authentication based on whether the prestored codeword and the received codeword match (that is, equality).

As described above, since the electronic system 1000 does not need to convert data to binary data when performing error correction on real number data, more accurate error correction or user authentication is possible. Since the electronic system 1000 does not need to convert real number data into binary data, error correction or user authentication processing may be performed more quickly.

In illustrating and describing FIG. 1, the electronic apparatus 100 generates a codeword, and the server device 200 receives and uses the codeword. However, in some implementations, the server device 200 may generate a codeword or a helper matrix, and the electronic apparatus 100 may receive the generated codeword or the helper matrix, and may use the received codeword or helper matrix from the server device 200.

In illustrating and describing FIG. 1, the device for generating a codeword by acquiring real number data and the device for performing user authentication using the generated codeword are shown and described as different, but in some implementations, the above-described operation may be performed on one device. For example, in an electronic apparatus according to some embodiments, such as a smartphone, operations of directly extracting biometric information from a user, generating a codeword based on the extracted information, and performing user authentication by comparing the generated codeword with a pre-generated codeword may be performed on one device.

Although it has been described that the electronic apparatus 100 extracts biometric information and generates a codeword with the extracted information, the extraction of biometric information and the operation of generating a codeword using the extracted biometric information may be performed in another separate device.

In some implementations, three or more devices may operate organically to perform user authentication. For example, assuming that a user terminal device, a first server and a second server operate organically to perform the user authentication, when a codeword for user authentication is stored in the first server and if a service in the second server is to be used, the codeword generated by the user terminal device may be provided to the first server. The first server provided with the codeword may perform user authentication and provide the result to the second server, so that the user may use the service in the second server.

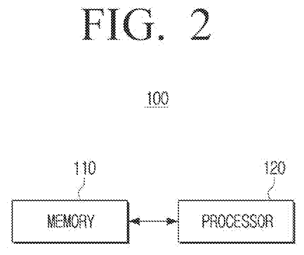

FIG. 2 is a block diagram illustrating a configuration of an electronic apparatus according to an embodiment.

Referring to FIG. 2, the electronic apparatus 100 may include a memory 110 and a processor 120.

At least one instruction related to the electronic apparatus 100 may be stored in the memory 110. For example, various programs (or software) for operating the electronic apparatus 100 according to various embodiments may be stored in the memory 110.

The memory 110 may store a helper matrix. The memory 110 may store a generated vector using a helper matrix. In addition, the memory 110 may store real number data to generate a helper matrix.

In some embodiments, the memory 110 may be implemented as a memory physically distinguished from the processor 120. In this case, the memory 110 may be implemented as at least one of a memory embedded within the electronic apparatus 100 or a memory detachable from the electronic apparatus 100 according to the usage of data storage.

For example, the memory 110 may be implemented as at least one of a volatile memory such as a dynamic random access memory (DRAM), a static random access memory (SRAM), a synchronous dynamic random access memory (SDRAM), or a non-volatile memory (for example, one time programmable ROM (OTPROM), programmable ROM (PROM), erasable and programmable ROM (EPROM), electrically erasable and programmable ROM (EEPROM), mask ROM, flash ROM, a flash memory (for example, NAND flash or NOR flash), a hard disk drive (HDD) or a solid state drive (SSD), a memory card (for example, a compact flash (CF), secure digital (SD), micro secure digital (micro-SD), mini secure digital (mini-SD), extreme digital (xD), multi-media card (MMC), etc.), an external memory (for example, a universal serial bus (USB) memory) connectable to the USB port, or the like.

In some embodiments, the memory 150 may be implemented as an internal memory such as a read-only memory (ROM) (for example, electrically erasable programmable read-only memory (EEPROM)), a random-access memory (RAM) included in the processor 120.

The processor 120 may control the overall operation of the electronic apparatus 100. For example, the processor 120 may control overall operation of the electronic apparatus 100 by executing at least one instruction stored in the memory 110.

The processor 120 may comprise a single device such as a central processing unit (CPU), a micro controller unit (MCU), a micro processing unit (MPU), a controller, a system on a chip (SoC), a large scale integration (LSI), an application-specific integrated circuit (ASIC), a field programmable gate array (FPGA), an application processor (AP), etc. or may be composed of the combination of a plurality of devices such as a central processing unit (CPU), graphics processing unit (GPU), or the like. In some embodiments, the processor 120 may include a plurality of devices, e.g., a plurality of CPUs or MCUs, etc.

The processor 120 may perform a key generation operation. Here, the key generation operation may be an operation of generating a codeword and a helper matrix. For example, the processor 120 may select one vector of a plurality of vectors as a codeword, where the selected vector (i.e., the codeword) includes a plurality of elements and has a predetermined size. When the codeword is selected, the processor 120 may store the codeword in the memory 110 or transmit the codeword to the server device 200.

In some implementations, the codeword may be selected (or generated) by an external device (or server device), and the electronic apparatus 100 may receive and use the codeword selected by the external device.

The processor 120 may generate a helper matrix by using the selected codeword and real number data. For example, the processor 120 may select a random orthogonal matrix for moving real number data in a random direction, calculate a rotation matrix for rotationally moving the real number data, and generate the helper matrix by using the real number data, the selected random orthogonal matrix, and the calculated rotation matrix. A detailed operation of generating the helper matrix will be described later with reference to FIGS. 6 and 7.

When user authentication is performed, the processor 120 may calculate a vector (that is, decoding codeword) using the helper matrix pre-generated in the input real number data. For example, the processor 120 may, based on new real number data being input, calculate a vector including a plurality of elements by matrix-multiplying the helper matrix by the new real number data.

In some embodiments, when the electronic apparatus 100 itself performs user authentication, the processor 120 may perform user authentication by comparing a pre-generated codeword with the vector calculated in the previous process. For example, the processor 120 may calculate the dot product sum of the pre-generated codeword and the calculated vector, and when the size of the calculated dot product sum is smaller than the preset size, it may be determined that the codeword and the vector are identical.

In some embodiments, the processor 120 may perform error correction on the calculated vector and perform user authentication by comparing the error-corrected vector (i.e., decoding codeword) with a pre-stored codeword.

As described above, since the electronic apparatus 100 does not need to convert data to binary data when performing error correction on real number data, more accurate error correction or user authentication is possible. In addition, since the electronic apparatus 100 according to the disclosure does not need to convert data into binary data, it is possible to more quickly perform error correction or user authentication processing.

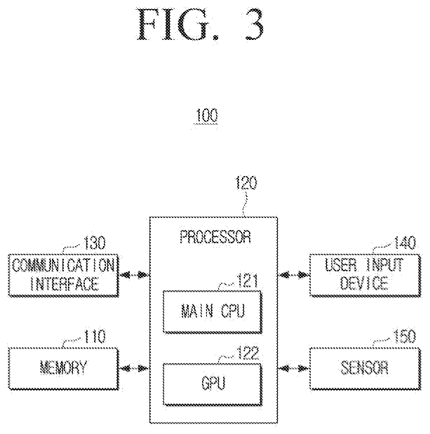

FIG. 3 is a block diagram illustrating a detailed configuration of an electronic apparatus.

Referring to FIG. 3, the electronic apparatus 100 may include a memory 110, a processor 120, a communication interface 130, a user input device 140, and a sensor 150.

A configuration of the memory 110 and the processor 120 has been described with reference to FIG. 2 and an overlapped description will be omitted for conciseness.

The communication interface 130 may include circuitry and may transmit information with an external device. The communication interface 130 may include one or more communication modules. For example, the communication modules may include one or more of a Wi-Fi module, a Bluetooth module, a local area network (LAN) module, a wireless communication module, or the like. Each communication module may be implemented as at least one hardware chip.

The wireless communication module may include at least one communication chip performing communication according to various wireless communication standards such as ZigBee, Ethernet, universal serial bus (USB), mobile industry processor interface camera serial interface (MIPI CSI), 3rd generation (3G), 3rd generation partnership project (3GPP), long term evolution (LTE), LTE advanced (LTE-A), 4th generation (4G), 5th generation (5G), or the like. Embodiments are not limited thereto, and the communication interface 130 may use at least one communication module among various communication modules.

The processor 120 may include a main CPU 121 and a GPU 122.

The main CPU 121 may access the memory 110 and perform booting using an operating system stored in the memory 110. The main CPU 121 may perform various operations using various programs and contents data, or the like, stored in the memory 110. According to an embodiment, the main CPU 121 may copy a program stored in the memory 110 to random access memory (RAM) according to an instruction stored in read-only memory (ROM), access the RAM, and execute a corresponding program.

The GPU 122 may correspond to a high performance processing device for graphics processing, and may be a specialized electronic circuit designed to accelerate image generation in a frame buffer to quickly process and change a memory and output the processed result to a screen. In addition, the GPU 122 may denote a visual processing unit (VPU).

The user input device 140 is configured to receive various user commands and information. The processor 120 may load the user commands and execute a function corresponding to a user command input through the user input device 140, or store information input through the user input device 140 in the memory 110. In some embodiments, the user input device 140 may be a keyboard, mouse, touchscreen, or the like.

The sensor 150 may generate real number data. The sensor 150 may be a camera capturing a face, or a microphone (not shown) for reading a user's voice. In some implementations, the processor 120 may perform an operation such as extraction/editing of the data generated by the sensor 150 to generate real number data. For example, the processor 120 may extract a user's face from the image captured by the sensor 150, and extract only real number data required for face recognition from the extracted face.

In illustrating and describing FIG. 3, five basic elements (i.e., the memory 110, processor 120, communication interface 130, user input device 140 and sensor 150) are illustrated and described. However, in some embodiments, the electronic apparatus 100 may include other elements in addition to the aforementioned elements, and some of the aforementioned elements may be omitted.

It has been described that the processor 120 includes only the main CPU 121 and the GPU 122 in the illustrated example of FIG. 3, but in some implementations, the processor 120 may further include an arithmetic circuit that performs the above-described key generation operation and/or vector generation operation.

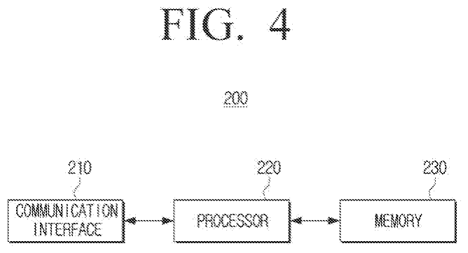

FIG. 4 is a block diagram illustrating a configuration of a server device according to an embodiment.

The server device 200 may include a communication interface 210, a processor 220, and a memory 230.

The communication interface 210 is a configuration capable of transmitting and receiving information to and from the server device 200. The communication interface 210 may receive biometric information or a codeword from the electronic apparatus 100. Thereafter, the communication interface 210 may transmit the authentication result to the electronic apparatus 100.

The memory 230 may store at least one instruction related to the server device 200. For example, various programs (or software) for operating the server device 200 may be stored in the memory 230 according to various embodiments.

The memory 230 may store a helper matrix. The stored helper matrix may be generated by the server device 200 or received from the electronic apparatus 100 through the communication interface 210.

The memory 230 may store the vector generated using the helper matrix. The memory 230 may store real number data to generate a helper matrix.

The processor 220 may comprise a single device such as a central processing unit (CPU), a micro controller unit (MCU), a micro processing unit (MPU), a controller, a system on a chip (SoC), a large scale integration (LSI), an application-specific integrated circuit (ASIC), a field programmable gate array (FPGA), an application processor (AP), etc. or may be composed of the combination of a plurality of devices such as a central processing unit (CPU), graphics processing unit (GPU), or the like. In some embodiments, the processor 120 may include a plurality of devices, e.g., a plurality of CPUs or MCUs, etc.

The processor 220 may control each element in the server device 200. When biometric information is received from the electronic apparatus 100, the processor 220 may calculate a vector using a pre-stored helper matrix. In some implementations, a vector calculated by the electronic apparatus 100 may be received from the electronic apparatus 100.

The processor 220 may perform user authentication using the pre-stored codeword and the calculated vector. For example, the processor 220 may determine whether the pre-stored codeword and the calculated vector are the same or whether the dot product of the codeword and the calculated vector is less than a preset value.

The processor 220 may control the communication interface 210 to transmit the user authentication result.

As described above, since the server device 200 does not need to convert real number data to binary data when performing error correction on real number data, more accurate error correction or user authentication is possible. Since the server device 200 does not need to convert real number data into binary data, error correction or user authentication processing may be performed more quickly.

In illustrating and describing FIG. 4, only three basic elements (i.e., the communication interface 210, the processor 220 and the memory 230) are illustrated and described, but in some implementations, the server device 200 may further include additional elements for performing a function unique to the server device 200 in addition to the above-described configuration.

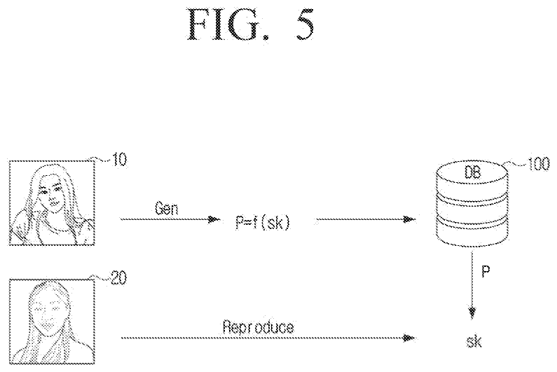

FIG. 5 is a conceptual diagram for describing a fuzzy extractor according to an embodiment.

A fuzzy extraction method is a method of extracting an encryption key from biometric information itself.

The fuzzy extraction method generates a helper matrix P from the biometric information x, and the generated helper matrix enables codewords to be restored when biometric information similar to pre-registered biometric information is later received.

For example, as shown in FIG. 5, when the helper matrix P is generated using the first real number data 10 at the time of initial registration, if second real number data 20 which is not the same but similar to the data at the time of initial registration is presented at the time when user authentication is performed, a codeword sk may be generated using the second real number data 20 and the helper matrix P.

Since biometric data such as a fingerprint/iris has a binary data structure, error correction may be performed using a technology such as a Hamming distance metric.

However, since the Hamming distance metric may be applied only to binary data, the Hamming distance metric technology cannot be directly applied to real number type biometric data such as a face and/or a voice.

In order to overcome this limitation, there is a method of converting real number data into binary data and using the same. However, when using this conversion process, there is a problem in that the accuracy is lowered and the speed becomes also slower.

In order to solve this problem, various embodiments use an error correction (ECC) technology applicable to real number data, and below, the new error correction technology will be described in detail.

The error correction for the real number data according to various embodiments may operate in an nth sphere satisfying Equation 1 below.

Sn={x=(x1,x2, . . . ,xn)1x12+x22+ . . . +xn2=1} [Equation 1]

Hereinabove, the nth sphere is defined as Sn, but in some implementations, the nth sphere may be defined as Sn-1.

In addition, a distance between two vectors in the sphere may be calculated using a cosine function, and an operation may be performed on the two vectors using the sphere coordinates.

The decoding may be performed by finding the nearest vector using orthogonal coordinates.

In this example, the codeword may be defined as Equation 2.

C=Uᵢ₌₁^{l}Cᵢ [Equation 2]

Here, C is a codeword, and Ci is denoted by the following expression:

Cᵢ={x₁, x₂, . . . , xₙ)∈ Sⁿ wt(x)=i and xⱼ=xₖ if xⱼ, xₖ≠0 for all j, k}.

For example, for n=4 (i.e., S4 of the four dimension), C1 may be {(±1,0,0,0), (0,±1,0,0),(0,0, ±1,0)(0,0,0, ±1)} In S4 of the four dimension, C2 may be:

$$\{ ( \frac{1}{\sqrt{2}} , \frac{1}{\sqrt{2}} , 0 , 0 ) , ( \frac{1}{\sqrt{2}} , 0 , \frac{1}{\sqrt{2}} , 0 ) , … , ( 0 , 0 , - \frac{1}{\sqrt{2}} , - \frac{1}{\sqrt{2}} ) \} .$$

Hereinafter, for ease of description, it is assumed that the codeword has C16 in S512. However, in some implementations, the number of elements of the codeword and the number of elements having a preset value may be used differently.

In CI, the minimum distance between two vectors is

$$1 - \frac{1}{{2}^{i - 1}} ,$$

and the minimum distance between two vectors in Ci and Cj is

$$\frac{1}{\sqrt{{2}^{{j - i}^{}}}}$$

where (i<j).

Accordingly, decoding may be performed through a process of finding the closest codeword for each element of Ci.

Hereinafter, a fuzzy extraction operation using the error correction technology will be described with reference to FIGS. 6 and 7.

FIG. 6 is a diagram illustrating a fuzzy extraction operation according to an embodiment.

Referring to FIG. 6, in order to apply the above-described ECC technology to a fuzzy extraction operation, a codeword C that may satisfy an ECC condition may be generated first. Specifically, some elements (e.g., 16) among the plurality of elements (e.g., 512) may have a preset value (e.g., +¼), and the remaining elements may have a value of 0, and one of the sets having a preset vector size may be selected. The generated codeword may be output by applying a hash function.

The helper matrix P for moving the input real number data 10 to the corresponding codeword C may be calculated.

When the same rotation processing is performed on the input real number data in the sphere environment, the value (C′) for the second real number data equals the difference value between the first real number data (W) (10) and the second real number data (W′) (20) (i.e., W-W′) added to the codeword (C).

In the above-described codeword, only a part of the plurality of elements have a predetermined value, so not all surfaces of the sphere are available as a codeword. There are positionable coordinates, and the vector value for the second real number data may find an adjacent corresponding coordinate and use the coordinate as a key value.

As described above, the value moved by the helper matrix is not the biometric information itself, so the value may be used as a public key.

In the above description, the vector is calculated by moving real number data only once, but in some implementations, the vector may be calculated by moving the real number data for a plurality of times. Hereinafter, an operation of moving real number data a plurality of times will be described with reference to FIG. 7.

FIG. 7 is a diagram illustrating a fuzzy extraction operation according to another embodiment.

Referring to FIG. 7, a random codeword may be selected from a set satisfying Equation 1 described above.

A random orthogonal matrix satisfying [symbol] ∈R^{n×n} may be selected. The random orthogonal matrix is a matrix for moving real number data in a random direction.

The rotation matrix for rotating and moving the real number data may be calculated. To be specific, when the real number data z satisfying z∈ [symbol] ⁿ is input, first intermediate data (u=Qz) may be calculated by matrix-multiplying the real number data z by the selected random orthogonal matrix Q.

The second intermediate data (v=C−uTcu) may be generated by performing unit orthogonalization (e.g., a Gram-Schmidt process) on the codeword C and the first intermediate data u.

The rotation angle θ between the codeword C and the first intermediate data u may be calculated.

The rotation matrix (R=I−uuT−vvT+[u v]Rθ[u v]T) may be calculated by using the calculated rotation angle θ, the first intermediate data u, and the second intermediate data v.

The helper matrix (H=RQ) may be generated using the finally calculated rotation matrix and the random orthogonal matrix.

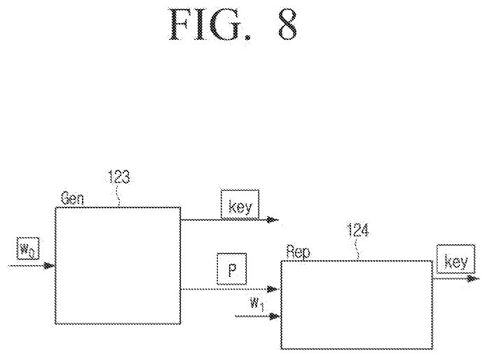

FIG. 8 is a diagram illustrating an operation of a generation module and a decoding module according to an embodiment.

Referring to FIG. 8, a key generation module 123 and a reproduction module 124 are provided. In some embodiments, the key generation module 123 and the reproduction module 124 may be a hardware configuration (e.g., an operation block in an ASIC) in the processor 120 or a software module.

The key generation module 123 may generate a codeword (key) or a helper matrix (P). Specifically, the key generation module 123 may select one vector of a plurality of vectors as the codeword, where the selected vector includes a plurality of elements and has a preset size. For example, if only 16 of the 512 elements of the codeword have a preset value and the remaining values have a value of 0, the codeword may be generated by randomly selecting 16 out of 512 elements that will have a preset value.

The key generation module 123 may generate the helper matrix P by reflecting the real number data W₀ to the generated codeword. Such a helper matrix P may be of a form in which real number data is moved only once on a sphere surface in some embodiments, or in other embodiments may be configured in a form in which real number data is moved a plurality of times. For example, if the helper matrix P is in a form that moves only once, the helper matrix P may be calculated by matrix multiplying real number data by a generated codeword.

When moving twice, the helper matrix may be generated by selecting a random orthogonal matrix for moving real number data in a random direction, calculating a rotation matrix for rotating real number data, and using real number data, the selected random orthogonal matrix, and the calculated rotation matrix.

Such a key generation module 123 may be implemented as an instruction for performing the key generation operation. In this case, the helper matrix P may be generated using the aforementioned GPU 122. In some implementations, the key generation module 123 may be implemented as hardware (e.g., ASIC, etc.) capable of performing the above-described operation.

The reproduction module 124 may generate a vector when real number data W1 is input. Specifically, the reproduction module 124 may calculate a vector by matrix-multiplying the pre-generated helper matrix by the real number data W₁. The reproduction module 124 may enable each element in the calculated vector to have a predetermined value or a value of 0, so that when real number data W₁ similar to real number data W₀ used in generating the helper matrix is input, the same key (or vector) may be generated.

When real number data having noise is input, the reproduction module 124 may decode a unique codeword in which an angle difference between the codeword and the input real number data is within the range of Equation 3 below.

$${cos}^{- 1} ( max \{ 1 - \frac{1}{{2}^{m - 1}} \cdot \frac{1}{\sqrt{2}} \} ) / 2 \qquad [ Equation 3 ]$$

In some implementations, the reproduction module 124 may be implemented as a set of instructions (i.e., a program) for performing the reproduction operations. In this case, the vector may be generated using the aforementioned GPU 122. In some implementations, the reproduction module 124 may be implemented as hardware (e.g., ASIC, etc.) capable of performing the reproduction operation.

As described above, in the fuzzy extraction, there is no need to convert the real number data into binary data, and thus accuracy does not fall. Since the fuzzy extraction does not require a separate conversion process, faster error correction or user authentication processing is possible.

It has been described that the error correction technology for real number data is applied only to biometric information, but the above real number data is not limited to biometric information and may be various information (e.g., position information according to an antenna signal) and may be applied to various fields.

In illustrating and describing FIG. 8, it has been described that the key generation module 123 and the reproduction module 124 are components in the electronic apparatus 100, but at least one of the above-described components may be provided in the server device 200.

In the illustrated example, one device is illustrated as including both the key generation module 123 and the reproduction module 124, but in some implementations, the electronic apparatus 100 may include only the key generation module 123 or only the reproduction module 124.

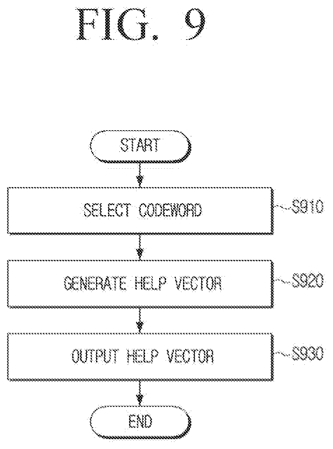

FIG. 9 is a flowchart illustrating a data processing method according to an embodiment.

Referring to FIG. 9, a codeword is selected in operation S910. For example, one vector of a plurality of vectors is selected as the codeword, where the one vector (i.e., the codeword) includes multiple elements and has a predetermined size. For example, the vector having a predetermined size in which a predetermined number of elements among the plurality of elements may have a same value other than zero. For example, the vector may include 512 elements, and 16 out of 512 elements may have a value of ±¼.

The helper matrix is generated in operation S920. For example, the helper matrix may be generated by using the selected codeword and the real number data. Here, the helper matrix is a vector that relatively moves the value of the sphere surface on the surface of the sphere, and in some embodiments may be one movement on the surface of the sphere, or in other embodiments may be a plurality of movements. For example, in the case of a plurality of movements, the helper matrix may be calculated using a random orthogonal matrix and a rotation matrix.

The helper matrix is output in operation S930. The helper matrix may be utilized as a public key.

As described above, the data processing method generates a helper matrix for moving real number data on a spherical surface, so that the real number data may be directly used without conversion into binary data.

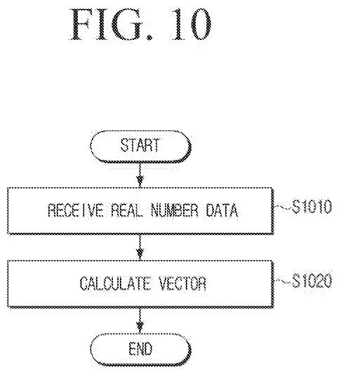

FIG. 10 is a flowchart illustrating a data processing method according to an embodiment.

Referring to FIG. 10, real number data is received in operation S1010.

A vector is calculated in operation S1020. For example, a vector including a plurality of elements is calculated by reflecting the input real number data to a helper matrix that relatively moves a value of a sphere surface on the sphere surface.

After calculation, an equality of the calculated vector and the codeword corresponding to the helper matrix may be determined. A dot product sum of the calculated vector and the codeword corresponding to the helper matrix may be calculated, and an equality based on whether the size of the calculated dot product sum is smaller than a predetermined size may be determined.

After the calculation above, error correction for the calculated vector may be performed. An element value of each of a plurality of elements constituting the vector may be approximated to a predetermined value or a zero value.

As described above, the data processing method may perform error correction without separately converting real data into binary data or check whether the real data is identical to existing data, and thus more precise error correction or authentication for real data may be performed.

Since the detailed operation of each step has been described above, a detailed description thereof will be omitted for conciseness.

In some embodiments, the above-described methods according to various embodiments may be implemented in the form of an application that may be installed in an electronic apparatus.

In some embodiments, the above-described methods according to various embodiments may be implemented only by software upgrade or hardware upgrade of an electronic apparatus.

Various embodiments described above may be performed through an embedded server provided in the electronic apparatus or at least one external server of the electronic apparatus.

The various embodiments described above may be implemented as software including instructions stored in a machine-readable storage media which is readable by a machine (e.g., a computer). The device may include the electronic apparatus according to the embodiments, as a device which loads the stored instructions from the storage media and which is operable to execute the loaded instructions. When the instructions are executed by a processor 120, the processor 120 may directly perform functions corresponding to the instructions using other components or the functions may be performed under a control of the processor. The instructions may include code contain a code made by a complier or a code executable by an interpreter. The machine-readable storage media may be provided in a form of a non-transitory storage media. The ‘non-transitory’ means that the storage media does not include a signal and is tangible, but does not distinguish whether data is stored semi-permanently or temporarily in the storage media.

The method according to the various embodiments described herein may be provided while being included in a computer program product. The computer program product may be traded between a seller and a purchaser as a commodity. The computer program product may be distributed in the form of a machine-readable storage medium (e.g.: a compact disc read only memory (CD-ROM)), or distributed online through an application store (e.g.: PLAYSTORE™). In the case of online distribution, at least a portion of the computer program product may be at least temporarily stored in a storage medium such as a server of a manufacturer, a server of an application store, or a memory of a relay server, or temporarily generated.

The various embodiments described above may be implemented in a recordable medium which is readable by a computer or a device similar to the computer using software, hardware, or the combination of software and hardware. In some cases, embodiments described herein may be implemented by the processor itself. According to a software implementation, embodiments such as the procedures and functions described herein may be implemented with separate software modules. Each of the software modules may perform one or more of the functions and operations described herein.

According to various embodiments described above, computer instructions for performing processing operations of a device according to the various embodiments described above may be stored in a non-transitory computer-readable medium. The computer instructions stored in the non-transitory computer-readable medium may cause a particular device to perform processing operations on the device according to the various embodiments described above when executed by the processor of the particular device.

The non-transitory computer-readable medium is not a medium storing data for a short period of time such as a register, a cache, or a memory, but may refer to a medium that semi-permanently stores data and is readable by a machine. Specific examples of the non-transitory computer-readable medium may include a CD, a DVD, a hard disk drive, a Blu-ray disc, a USB, a memory card, and a ROM.

Each of the elements (e.g., a module or a program) according to various embodiments may be comprised of a single entity or a plurality of entities, and some sub-elements of the abovementioned sub-elements may be omitted, or different sub-elements may be further included in the various embodiments. Alternatively or additionally, some elements (e.g., modules or programs) may be integrated into one entity to perform the same or similar functions performed by each respective element prior to integration. Operations performed by a module, a program, or another element, in accordance with various embodiments, may be performed sequentially, in a parallel, repetitively, or in a heuristically manner, or at least some operations may be performed in a different order, omitted or a different operation may be added.

While various example embodiments have been illustrated and described, the disclosure is not limited to the specific embodiments described above. It will be understood by those skilled in the art that various changes in form and details may be made therein without departing from the true spirit and full scope of the disclosure, including the appended claims and their equivalents.

What is claimed is:

1. A data processing method comprising:
selecting, by at least one processor as a codeword, a vector from among a plurality of vectors, the vector comprising multiple elements and having a predetermined size;
generating, by the at least one processor, a helper matrix by using the codeword and real number data; and
outputting, by the at least one processor, the helper matrix.

2. The data processing method of claim 1, wherein a predetermined number of elements of the multiple elements of the vector in the predetermined size have a same value other than zero,
wherein the vector includes 512 elements, and
wherein 16 elements of the 512 elements have a value of ±¼.

3. The data processing method of claim 1, wherein the helper matrix defines a vector that relatively moves a value of a sphere surface on a surface of a sphere.

4. The data processing method of claim 1, wherein the generating the helper matrix comprises:
selecting a random orthogonal matrix for moving the real number data in a random direction;
calculating a rotation matrix for rotationally moving the real number data; and
calculating the helper matrix by using the real number data, the random orthogonal matrix, and the rotation matrix.

5. The data processing method of claim 4, wherein the calculating the rotation matrix comprises:
calculating first intermediate data by matrix—multiplying the random orthogonal matrix by the real number data;
generating second intermediate data by performing unit orthogonalization processing on the codeword and the first intermediate data;
calculating a rotation angle between the codeword and the first intermediate data; and
generating the rotation matrix by using the rotation angle, the first intermediate data, and the second intermediate data.

6. The data processing method of claim 1, wherein the real number data is at least one of face information data, voice information data, or location information data.

7. A data processing method comprising:
receiving real number data; and
calculating a vector comprising a plurality of elements by reflecting the real number data to a helper matrix that relatively moves a value of a sphere surface on a surface of a sphere.

8. The data processing method of claim 7, further comprising:
determining equality of the vector and a codeword that corresponds to the helper matrix.

9. The data processing method of claim 8, wherein the determining the equality comprises:
calculating a dot product sum of the vector and the codeword that corresponds to the helper matrix; and
determining the equality based on whether a size of the dot product sum is smaller than a predetermined size.

10. The data processing method of claim 7, further comprising:
performing error correction on the vector.

11. The data processing method of claim 10, wherein the performing error correction comprises approximating an element value of each of the plurality of elements of the vector to a predetermined value or a zero value.

12. An electronic apparatus comprising:
a memory that stores at least one instruction; and
a processor that loads the at least one instruction and executes the at least one instruction,
wherein the processor, by executing the at least one instruction, selects, as a codeword, a vector of a plurality of vectors, the vector comprising a plurality of elements and having a predetermined size, generates a helper matrix by using the codeword and real number data, and outputs the helper matrix.

13. The electronic apparatus of claim 12, wherein the processor, by executing the at least one instruction:
selects a random orthogonal matrix for moving the real number data in a random direction,
calculates a rotation matrix for rotationally moving the real number data, and
generates the helper matrix by using the real number data, the random orthogonal matrix, and the rotation matrix.

14. The electronic apparatus of claim 13, wherein the processor, by executing the at least one instruction:
calculates first intermediate data by matrix multiplying the random orthogonal matrix by the real number data,
generates second intermediate data by performing unit orthogonalization processing on the codeword and the first intermediate data,
calculates a rotation angle between the codeword and the first intermediate data, and
calculates the rotation matrix by using the rotation angle, the first intermediate data, and the second intermediate data.

15. The electronic apparatus of claim 12, wherein the processor, by executing the at least one instruction, based on new real number data being input, calculates a vector comprising a plurality of elements by reflecting the new real number data to the helper matrix.

16. A system comprising an electronic apparatus and a server, wherein:
the electronic apparatus includes a sensor that senses biometric information and generates first real number data based on the biometric information, and a communication interface that transmits the first real number data to the server; and
the server includes a memory that stores at least one instruction, and at least one processor that loads the at least one instruction and executes the at least one instruction to at least:
select, as a codeword, a first vector of a plurality of vectors, the first vector comprising a plurality of elements and having a predetermined size;
generate a helper matrix by using the codeword and second real number data;
receive the first real number data from the electronic apparatus;
calculate a second vector comprising a plurality of elements by reflecting the first real number data to the helper matrix; and determine equality of the second vector and the codeword that corresponds to the helper matrix.

17. The system of claim 16, wherein the determining the equality comprises:
calculating a dot product sum of the second vector and the codeword that corresponds to the helper matrix; and
determining the equality based on whether a size of the dot product sum is smaller than a predetermined value.

18. The system of claim 16, wherein the biometric information is at least one of face information or voice information.

19. The system of claim 16, wherein the helper matrix defines a vector that relatively moves a value of a sphere surface on a surface of a sphere.

20. The system of claim 16, wherein the at least one processor generates the helper matrix by at least:
selecting a random orthogonal matrix for moving the second real number data in a random direction;
calculating a rotation matrix for rotationally moving the second real number data; and
calculating the helper matrix by using the second real number data, the random orthogonal matrix, and the rotation matrix.
